(19) United States
(12) Patent Application Publication
(10) Pub. No.: US 2021/0293027 A1
(43) Pub. Date: Sep. 23, 2021

(54) A T-PIECE FOR USE IN A WATER DIVERTER

(71) Applicant: Rain Harvesting Pty Ltd, Milton (AU)

(72) Inventor: Anton Lee See, Milton (AU)

(21) Appl. No.: 16/604,561

(22) PCT Filed: Apr. 6, 2018
(86) PCT No.: PCT/AU2018/050315

§ 371 Date: Oct. 10, 2019

(30) Foreign Application Priority Data
Apr. 12, 2017 (AU) 2017901345

(51) Int. Cl. E04D 13/08; E03B 1/04; E04D 13/064; F16L 41/02

(52) U.S. Cl. CPC E04D 13/08; E03B 1/042; E04D 2013/0853; F16L 41/021; E04D 2013/0813; E04D 13/0645

(57) ABSTRACT

A T-piece for use in a water diverter is disclosed. The T-piece comprises an inlet for contaminated water and uncontaminated water, a first outlet for contaminated water, a second outlet for uncontaminated water, and a chamber between the inlet, the first outlet, and the second outlet. A portion of the chamber expands outwardly away from the inlet in order that the contaminated water adhered to the surface of the inlet becomes separated from the surface of the chamber. A water diverter comprising the T-piece is also disclosed.

### TECHNICAL FIELD

The present invention relates to rainwater collection systems and in particular to a T-piece suitable for use in, possibly among other things, a water diverter that separates or diverts an initial flow of contaminated rainwater flowing from a collection area, thereby preventing the initial flow of contaminated rainwater from flowing into a tank or other storage receptacle, whilst also allowing subsequent flow of uncontaminated rainwater to flow into the tank or receptacle. The present invention also relates to a water diverter comprising the T-piece.

### BACKGROUND

In water collection systems such as those used for the collection of rainwater from the roof of a domestic building, it is desirable to divert the initial flow of water away from reservoirs or tanks in which the water is stored. This is because, during dry periods between rainfall episodes, the building roof and guttering often collect impurities including animal or bird droppings, dust, grit and other airborne material, much or all of which is often then flushed from the roof and guttering with the initial flow of water from the next rainfall.

Diverters (so-called “first-flush diverters”) have been developed for installation in water collection systems. For example, AU 692835 and AU 2002300002 A1 (the disclosures of which are incorporated herein by reference) describe water diverters both of which include a conventional pipe T-piece. The T-piece is connected in the rainwater flow path. More specifically, the vertical “downpipe” which leads from the roof guttering and which therefore conveys rainwater flowing out of the guttering connects to a generally horizontal pipe (via an elbow joint or the like) and this horizontal pipe then connects to the first of the horizontal openings in the T-piece. The perpendicular, vertical opening in the T-piece in turn connects to a fall pipe, which typically has a slow-release or delayed-release outlet at its base, and which operates to collect the initial flow of water (or a predetermined volume of the initial flow) containing unwanted impurities initially flushed from the roof. And the other (second) of the T-piece's horizontal openings connects to a horizontal pipe that leads ultimately (possibly after one or more further corners or elbows or the like, as required) to a water storage tank or the like where uncontaminated, clean rainwater is to be stored.

The operation of these conventional first flash diverters is explained in more detail in the above referenced earlier patents. However, in summary, conventional first flush diverters typically operate using a float-type ball valve. Basically, a floating valve ball is contained inside the vertical fall pipe. During initial periods of rainfall, the water that flows off the roof flows out of the guttering into the downpipe and then into the first horizontal opening (inlet) in the T piece. Upon entering the T piece, the water then falls through the vertical opening in the T piece and into the fall pipe. Because of the slow-release opening at the bottom end of the fall pipe, water falls into the fall pipe at a much greater rate than it exits through the slow-release or delayed-release opening. Consequently, the fall pipe quickly begins to fill, and as the fall pipe fills, the floating valve ball is floated upwards. Typically, the fall pipe is sized so that its volume corresponds to the predetermined volume of water that is desired to be diverted away from the storage tank during initial periods of rainfall. Usually, the larger the surface area of the roof from which water is being collected, the larger the amount of contaminants that could potentially be flushed from the roof during an initial rainfall, and consequently the larger the volume the fall pipe will need to have to accommodate the diversion of water containing these contaminants and prevent this from reaching the storage tank. In any case, whatever the volume of the fall pipe, once a sufficient volume of initially-flushed water has fallen through the vertical opening in the T piece to fill the fall pipe, the valve ball will consequently have been floated all the way up to the top of the fall pipe, and in fact its buoyancy (and the water beneath it in the fall pipe forcing it upward) will force the valve ball up into engagement with a valve seat that is located in or just below the vertical opening in the T piece, thereby effectively sealing off the vertical opening in the T piece. Once the vertical opening the T piece, and thus the fall pipe, are “closed” in this way, any water that subsequently flows off the roof and into the guttering will flow into the horizontal inlet in the T piece, but it will then flow directly over the top of the vertical opening (which it is to be recalled is now “closed” by the ball valve”) and it then exits the T piece through the second horizontal outlet that leads to the tank or storage receptacle. This is thus how the initial flow of contaminated (or potentially contaminated) water is diverted, but subsequent, clean water is then allowed to flow to the storage tank.

The way the fall pipe empties is that, gradually, the slow-release outlet at the base of the fall pipe will allow the water that flowed into the fall pipe to flow (or leak) out the bottom, so that (although this may take some time) ultimately the fall pipe empties and the floating valve ball again returns to the bottom, until the next rainfall episode when the process repeats. If the outlet is a delayed-release outlet then the outlet allows the water to flow out the bottom of the fall pipe at a pre-determined time later.

However, there is a problem with many first flush diverters of the type described above, and the problem arises because the T piece at the top of the diverter is usually formed using a conventional pipe T-piece (i.e. a T-piece which essentially comprises a straight section of round pipe but which also has opening in the side wall to allow another round section of pipe of the same diameter connect thereto perpendicularly). The problem is that, very often, some of the initial flow of contaminated water tends to cling (or stick) to the interior wall surface inside the T-piece as it flows into the horizontal inlet of the T piece and through the T piece. Water can also “slosh” from side to side as it flows along the horizontal pipes (including the horizontal pipe leading into the T piece). This “sloshing” of the water from side to side as it flows along can also occur within the T piece. These two factors (clinging and sloshing) individually, and especially in combination, can lead to some of the water which forms part of the initial (contaminated) flow from the roof, which should therefore be diverted into the fall pipe, instead riding up the side walls inside the T piece and thereby flowing up and around and ultimately bypassing (or “dodging” or “skipping over”) the vertical opening in the bottom of the T piece that leads to the vertical fall pipe. Any water that avoids entering the fall pipe in this way consequently then flows directly on out of the horizontal outlet of the T piece and into the water storage tank, even though this water may contain contaminants and should therefore preferably be diverted into the fall pipe (at least until the required volume of initial flow has been diverted).

Furthermore, there is also often potential for water which flows off the roof, out of the guttering, into the downpipe, and then into the horizontal T piece inlet, when it enters the T piece, to splash or skip directly over the lower opening in the T piece that leads to the vertical fall pipe. Again, any water that avoids entering the fall pipe because it has skipped or splashed directly over the lower opening that leads to the fall pipe consequently then also flows directly on into the water storage tank, even though this water may contain contaminants.

The above problem of water that should be diverted into the fall pipe avoiding doing so (because it rides up and around, or skips or splashes all the way over, the vertical opening in the T piece), is exacerbated often when the initial flow of contaminated water is moving very quickly towards and into the T-piece, such as during a sudden and heavy storm. It is estimated that, in such situations, as much as 50% of the potentially contaminated water that should be diverted into the fall pipe can actually can skip over or otherwise avoid diversion into the fall pipe and end up in the tank.

It is thought that it may be desirable if the above problems could be ameliorated or reduced.

It will be clearly understood that, if a prior art publication is referred to herein, this reference does not constitute an admission that the publication forms part of the common general knowledge in the art in Australia or in any other country.

### SUMMARY OF THE INVENTION

With the foregoing in view, the present invention in one form, resides broadly in a T-piece for use in a water diverter, the T-piece comprising:
an inlet operable for connection to an at least approximately horizontal inflow pipe;
a first outlet operable for connection to the top of an at least approximately vertical fall pipe;
a second outlet operable for connection to an at least approximately horizontal outflow pipe;
a chamber between the inlet, the first outlet, and the second outlet;
wherein a portion of the chamber expands outwardly away from the inlet in order that inflowing water adhered or clinging to an internal surface of the inflow pipe or inlet becomes separated therefrom.

The outwardly expanding portion of the chamber creates a surface discontinuity between the inlet and the chamber which may help to prevent contaminated water from clinging to the chamber and undesirably bypassing the first outlet and exiting the second outlet instead. This will become more apparent from the description below.

In some embodiments the vertical cross-sectional area of the chamber is larger than the vertical cross-sectional area of the inlet.

According to an embodiment the length of the chamber between the inlet and the second outlet is greater than the distance across the first outlet (e.g. the diameter of the first outlet, if circular/round). This may help to further reduce the amount of contaminated water that undesirably skips the first outlet and exits through the second outlet. In some of these embodiments the length of the chamber between the inlet and the second outlet is between about 1.2 to 3 times, preferably between about 1.3 to 2 times, and more preferably between about 1.4 to 1.7 times greater than the distance across the first outlet.

The distance between the first outlet (for contaminated water) and the second outlet (for uncontaminated water) is not particularly limited. In an embodiment the first outlet is closer to the second outlet than to the inlet. In an alternative embodiment the first outlet is closer to the inlet than to the second outlet. These two embodiments allow for a reduction in the amount of material, e.g. plastic, that is used to make the T-piece. In another alternative embodiment the first outlet for contaminated water is equally positioned between the inlet and the second outlet for uncontaminated water.

According to another embodiment a horizontal distance separates the first outlet from the inlet. In some of these embodiments the horizontal distance and the distance across the first outlet (e.g. the diameter of the first outlet, if circular/round) have a ratio between about 0.2 to 1.5, preferably between about 0.4 to 1.0, and more preferably between about 0.5 to 0.8.

In some embodiments a vertical distance separates the first outlet from the inlet. According to some of these embodiments the vertical distance and the distance across the inlet have a ratio between about 0.2 to 1.5, preferably between about 0.4 to 1.0, and more preferably between about 0.5 to 0.8.

In some embodiments the chamber comprises a depressed pouch extending between the inlet and the first outlet. The depressed pouch lowers the position of a float where the float closes (seals) the first outlet as will be described below. The lowered position of the float allows for less restricted flow of uncontaminated water through the T-piece to a storage area.

According to some embodiments the chamber comprises:
a first side wall;
a second side wall opposing the first side wall;
a first end wall; and
a second end wall opposing the first end wall.

In some embodiments the distance between the first side wall and the second side wall is greater than the distance across the inlet. In some of these embodiments the ratio of the distance between the side walls and the distance across the inlet is between about 1.1 to 1.6, preferably between about 1.1 to 1.4, and more preferably between about 1.1 to 1.2.

According to an another embodiment the inlet projects away from the first end wall and the second outlet projects away from the second end wall.

In some embodiments the chamber comprises a top face and an inclined top surface that extends away from and below the top face. The T-piece may further comprise one or more ridges on the lower side of the top face. In some embodiments a plurality of ridges are spaced apart from each other in a parallel and/or perpendicular arrangement.

According to one embodiment the top face and the inclined top surface are manufactured together as a separate piece that is attached to the chamber.

The T-piece may be made of plastic in another embodiment.

In some embodiments the inlet, first outlet, and second outlet of the T-piece each independently comprise:
an outer portion;
an inner portion;
and an intermediate portion between the outer portion and the inner portion.

According to certain embodiments the distance across the outer portion (e.g. the diameter thereof if round/circular) is greater than the distance across the inner portion (e.g. the diameter thereof if round/circular) by up to about 5 mm and the distance across the intermediate portion (e.g. the diameter thereof if round/circular) progressively decreases from the outer portion to the inner portion.

In another form, the present invention resides broadly in a water diverter comprising:
a T-piece according to an embodiment described above;
an at least approximately horizontal inflow pipe connected to the inlet of the T-piece for passage of contaminated water and uncontaminated water from a collection area;
an at least approximately vertical fall pipe connected to and extending down from the first outlet of the T-piece for receiving contaminated water exiting the T-piece; and
an at least approximately horizontal outflow pipe connected to the second outlet of the T-piece for passage of uncontaminated water to a storage area.

In some embodiments the water diverter further comprises a float located inside the fall pipe adapted to reversibly close the first outlet of the T-piece. In some embodiments of the water diverter, the T-piece is positioned such that the inlet and the second outlet are located horizontally or approximately parallel with the ground. In other embodiments of the water diverter, the T-piece is positioned such that the inlet and the second outlet are located vertically or approximately perpendicular to the ground. Preferably, the inlet will be above the second outlet in the vertical orientation.

According to some embodiments the fall pipe has a fall pipe outlet with a valve at the lower end of the fall pipe.

In another form, the present invention resides broadly in a pipe T-piece comprising a chamber that has a first opening, a second opening, and a third opening, wherein
the first, second and third openings each include a round portion extending out from the chamber;
each said round portion is substantially cylindrical or at least round (circular) in cross section,
the principal axis of the first opening's round portion is parallel or co-linear with the principal axis of the second opening's round portion;
the principal axis of the third opening's round portion is at an angle (which could be, although it need not necessarily be, perpendicular) to the principal axes of the first and second openings' round portions;
at least where the first opening's round portion joins the chamber, moving in a direction into the chamber, the internal wall of the chamber diverges (i.e. flares) outwards from the internal wall of the first opening's round portion such that, at least near where the first opening's round portion joins the chamber, the chamber is wider in all dimensions than the first opening, and
where the first opening's round portion joins the chamber, at the join there is a quite sharp edge or at least a very small, tightly curved/rounded (or beveled) edge.

The curved/rounded (or beveled) edge is distinct from a large, or gradual curve or smooth transitioning join. The curved/rounded (or beveled) edge creates an effective surface discontinuity between the internal surface of the first opening's round portion and the surface of the internal wall of the chamber, at least near the join between the two.

In some embodiments of the pipe T-piece, at least where the second opening's round portion joins the chamber, moving in a direction into the chamber, the internal wall of the chamber diverges (flares) outwards from the internal wall of the second opening's round portion such that, at least near where second opening's round portion joins the chamber, the chamber is wider in all dimensions than the second opening, and where the second opening's round portion joins the chamber, at the join there is a quite sharp edge or at least a very small, tightly curved/rounded (or beveled) edge. The curved/rounded (or beveled) edge is distinct from a large, or gradual curve or smooth transitioning join. This results in an effective surface discontinuity between the internal surface of the second opening's round portion and the surface of the internal wall of the chamber, at least near the join between the two.

In some embodiments of the pipe T-piece, the size of the chamber in a dimension parallel with the principal axes of the first and second openings' round portions is such that the distance between where the first opening's round portion joins the chamber and where the second opening's round portion joins the chamber is greater than size (diameter) of the third opening.

In some embodiments of the pipe T-piece the third opening's round portion joins the chamber at a location that is closer to where the second opening's round portion joins the chamber and further away from where the first opening's round portion joins the chamber.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIGS. 1A-1D show perspective views of a T-piece according to an embodiment of the invention.

FIG. 2A illustrates a front view of the T-piece in FIGS. 1A-1D.

FIG. 2B illustrates a bottom view of the T-piece in FIGS. 1A-1D.

FIG. 2C illustrates a side view of the T-piece in FIGS. 1A-1D.

FIG. 2D illustrates another side view of the T-piece in FIGS. 1A-1D.

FIG. 2E illustrates a top view of the T-piece in FIGS. 1A-1D.

FIG. 3A schematically depicts a water diverter comprising the T-piece of FIGS. 1A-1D as an initial flow of contaminated rainwater enters the diverter.

FIG. 3B depicts the water diverter of FIG. 3A after the initial flow of contaminated water has been collected and uncontaminated water is flowing through the diverter to a storage area.

### DETAILED DESCRIPTION

The features of the T-piece 10 and water diverter 48 as depicted in the accompanying figures and their respective reference numeral(s) are listed in the table below.

| | Reference |
|---|---|
| Component | Numeral(s) |
| T-piece | 10 |
| Inlet | 14 |
| Outer portion of the inlet | 15 |
| Intermediate portion of the inlet | 16 |
| Inner portion of the inlet | 17 |
| Uncontaminated water outlet | 18 |
| Outer portion of the uncontaminated water outlet | 19 |
| Intermediate portion of the uncontaminated water outlet | 20 |
| Inner portion of the uncontaminated water outlet | 21 |
| Contaminated water outlet | 22 |
| Outer portion of the contaminated water outlet | 23 |
| Intermediate portion of the contaminated water outlet | 24 |
| Inner portion of the contaminated water outlet | 25 |
| Top face | 26 |
| Inclined top surface | 27 |
| First side wall | 30 |
| Second side wall | 31 |
| First end wall | 32 |
| Second end wall | 33 |
| Depressed pouch | 34 |
| Curved wall | 38 |
| Ridges | 42 |
| Water diverter | 48 |
| Inlet pipe | 50 |
| Outlet pipe | 51 |
| Fall pipe | 52 |
| Float | 53 |
| Fall pipe outlet | 54 |
| Valve | 55 |
| Contaminated water | 56 |
| Uncontaminated water | 57 |
| Diameter of the inner portion 25 of contaminated water | u |
| outlet 22 | |
| Horizontal distance separating inner portion 17 and inner | v |
| portion 25 | |
| Diameter of the inner portion 17 of inlet 14 | w |
| Vertical distance separating inner portionl7 and inner | x |
| portion 25 | |
| Distance between the first side wall 30 and the second side | y |
| wall 31 | |

As used herein, the term “collection area” refers to an area where rainwater is initially collected and most commonly includes the roof of a domestic building such as a house, townhouse, unit block or the like, as well as the roof of a commercial business premises such as a store, shop, hotel, warehouse, factory or the like. The term “storage area” refers to any area where collected rainwater is subsequently stored and includes one or more tanks such as a 3000 litre tank, a 5000 litre tank, and a 10000 litre tank typically found on domestic and commercial properties although the number and volume of the tank(s) is not intended to be limiting. The storage area may also be something other than a tank, like a water truck, dam, weir, or a lake.

Certain features of the T-piece and water diverter are described using the terms “outer” and “inner” which are intended to describe the position of the features relative to the central point in the middle of the T-piece. An outer feature is positioned further away from the central point of the T-piece relative to the position of an inner feature. Other features are described using the term “lower” which is intended to describe the position of that feature relative to the top of the T-piece. For instance, a lower end of a pipe connected to the T-piece is located further away from the top of the T-piece relative to the location of another end of the pipe. Similarly, features described using the term “upper” are intended to describe the position of that feature relative to the bottom of the T-piece. For example, an upper edge of a side wall is located further away from the bottom of the T-piece relative to the position of another edge(s) of the side wall. The terms “horizontal” and “vertical” are intended to describe features that are parallel to, and perpendicular to, the top of the T-piece respectively.

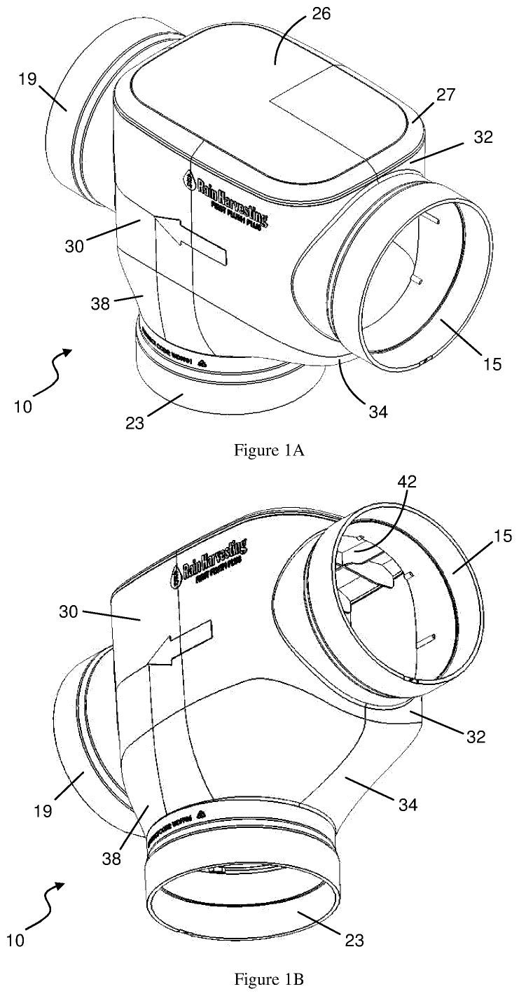

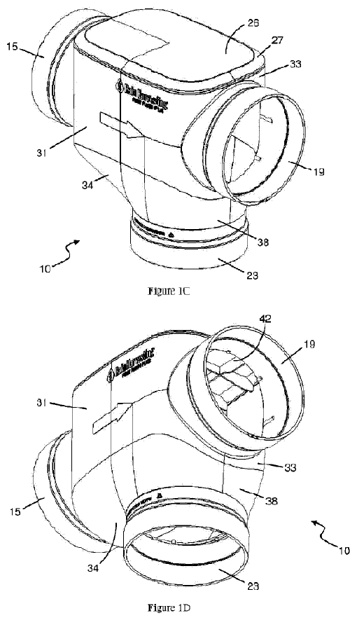

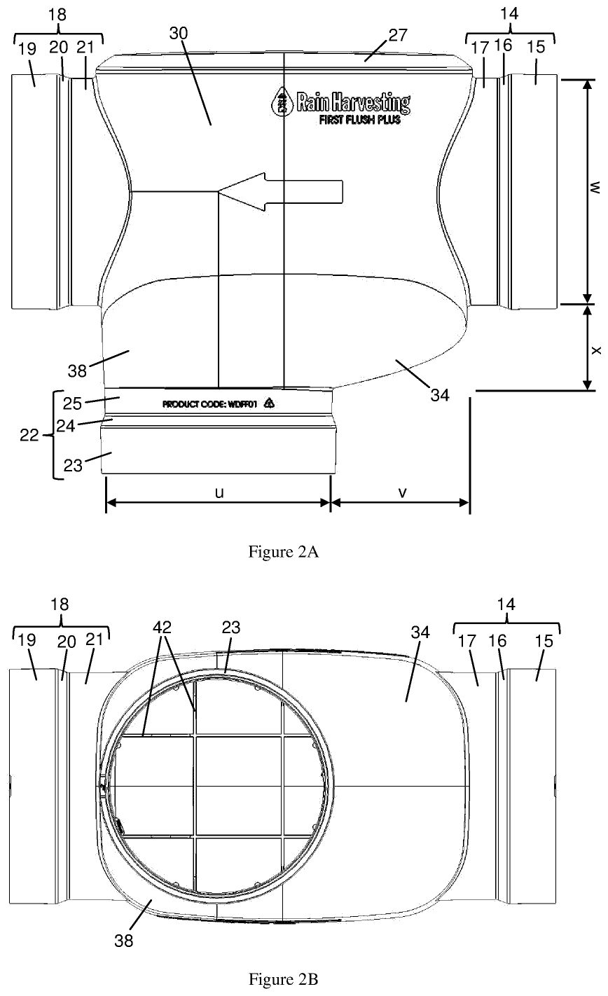

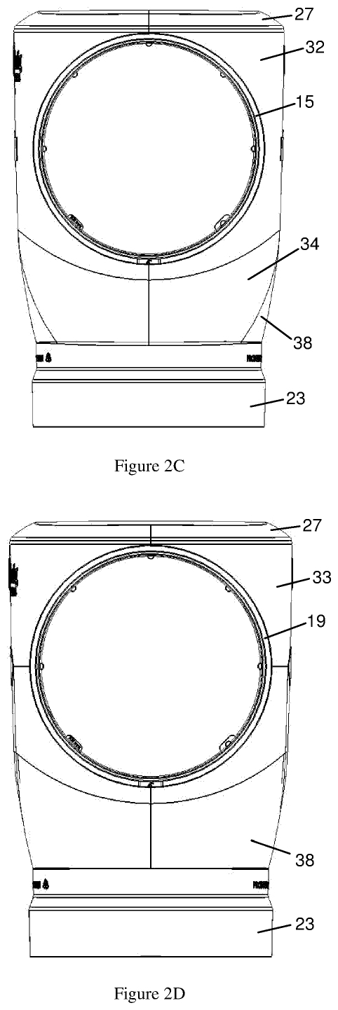

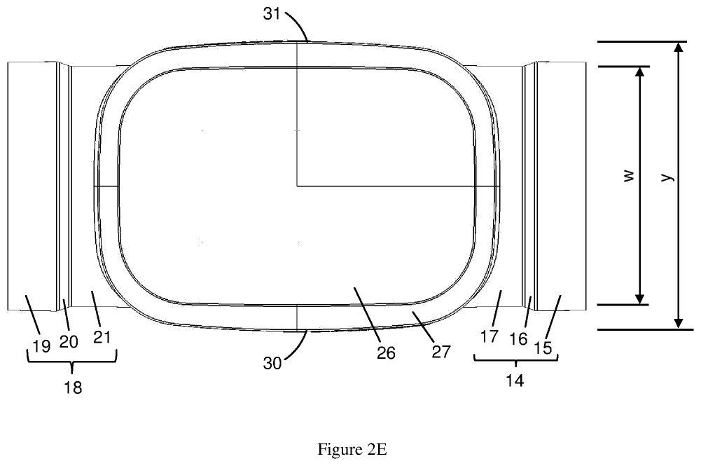

FIGS. 1A-1D and FIGS. 2A-2E illustrate a T-piece 10 for use in a water diverter according to an embodiment of the disclosure. Note that the orientation of the T-piece shown in FIGS. 2A-2D is the orientation in which it will usually be installed in use. The T-piece 10 has a horizontal inlet 14 through which all of the water from the collection area enters, a horizontal outlet 18 through which uncontaminated water flows to a storage area, a vertical outlet 22 through which an initial flow of contaminated water passes out of the T-piece 10, and a central chamber located between inlet 14, outlet 18, and outlet 22.

As best seen in FIG. 2A, inlet 14 has an outer portion 15, an inner portion 17, and a portion 16 that is intermediate of the outer portion 15 and inner portion 17. Portions 15 and 17 are cylindrical with the outer portion 15 having a diameter slightly larger than inner portion 17. The diameters of portions 15 and 17 differ by up to 5 mm, preferably 1 to 3 mm. Outer portion 15 is adapted to be connected to a (at least approximately horizontal) conduit or other fitting (not shown) that conveys rainwater flowing from the collection area. The diameter of inner portion 17 is smaller than the diameter of outer portion 15. Inner portion 17 is located adjacent to the central chamber of T-piece 10. The intermediate portion 16 has a progressively decreasing diameter from the outer portion 15 to the inner portion 17 and serves as a bridge between the outer 15 and inner 17 portions. The inner portion 17 of inlet 14 has a diameter labelled “w” in FIGS. 2A and 2E. Diameter “w” is not intended to be limited in any particular way. For example, diameter “w” may be in the range of 80 to 160 mm, preferably 100 to 130 mm, more preferably 110 to 125 mm, and even more preferably about 115 to 120 mm. Exemplary and non-limiting diameters of “w” and the outer portion 15 are 100 mm and 101.6 mm (4 inches) respectively.

Horizontal (uncontaminated water) outlet 18 and vertical (contaminated water) outlet 22 are similar in design to inlet 14.

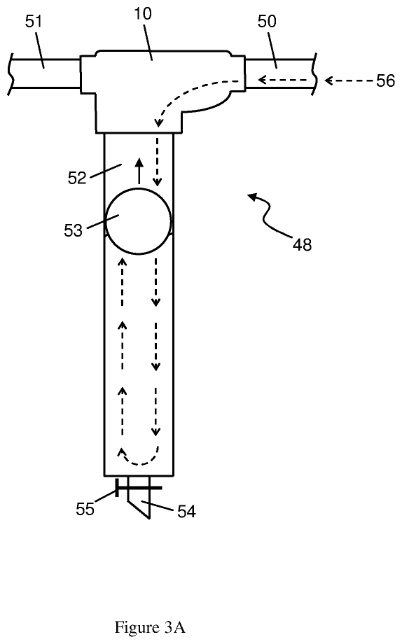

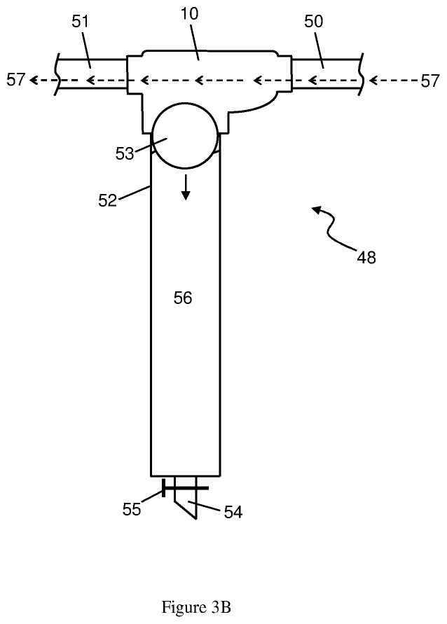

Outlet 18 is located adjacent to the central chamber and opposite to inlet 14. Outlet 18 has an outer portion 19, an inner portion 21, and an intermediate portion 20. Portions 19 and 21 are cylindrical with the outer portion 19 having a diameter that is about 3 to 5 mm larger than inner portion 21. Outer portion 19 is adapted to be connected to a (at least approximately horizontal) conduit or other fitting (not shown) that ultimately conveys uncontaminated rainwater to a storage area as will be described further below with respect to FIGS. 3A and 3B. Inner portion 21 is located adjacent to the central chamber of T-piece 10. Intermediate portion 20 connects outer portion 19 to inner portion 21 and has a progressively decreasing diameter from the outer portion 19 to the inner portion 21.

Outlet 22 is located at the bottom of the T-piece below the central chamber and in between the approximately horizontal inlet 14 and outlet 18 as best seen in FIG. 2A. Outlet 22 has an outer portion 23, intermediate portion 24, and an inner portion 25. Portions 23 and 25 are cylindrical with portion 23 having a diameter up to about 5 mm larger than portion 25. Outer portion 23 is adapted to be connected to a (at least approximately vertical) fall pipe (not shown) or other fitting for separating the initial flow of contaminated water as will be described below in FIGS. 3A and 3B. Inner portion 25 is located adjacent to the lower portion of the central chamber of T-piece 10. Intermediate portion 24 has a progressively decreasing diameter from the outer portion 23 to the inner portion 25.

The inner portion 25 of water outlet 22 has a diameter labelled “u” in FIG. 2A. Like diameter “w”, diameter “u” is not intended to be limited in any particular way. For example, diameter “u” may be in the range of 80 to 160 mm, preferably 100 to 130 mm, more preferably 110 to 125 mm, and even more preferably about 115 to 120 mm. The diameter “u” will suit the pipe to be connected to water outlet 22.

It is not necessary that inlet 14 and outlets 18 and 22 each have distinct outer portions 15, 19, 23, intermediate portions 16, 20, 24, and inner portions 17, 21, 25 as described above. For example, inlet 14, outlet 18, and outlet 22 may each be cylindrical in shape with one constant diameter along their length. The choice will depend on the size and nature of the conduits or other fittings to be connected to inlet 14 and outlets 18 and 22. For instance, the illustrated inner, intermediate, and outer portions are useful when standard sized plumbing pipe is connected to the inlet and outlets. The plumbing pipe will be received by outer portions 15, 19, and 23 and the end of the plumbing pipe will abut intermediate portions 16, 20, and 24. This way the diameter of the connected plumbing pipe will be the same as, and be continuous with, the diameter of the inner portions 17, 21, and 25.

A horizontal distance “v” shown in FIG. 2A separates inner portion 17 from inner portion 25. Distance “v” is not limited in any away. Example ranges of distance “v” include 40 to 120 mm, 60 to 100 mm, and 70 to 90 mm. Preferably, the ratio of distance “v” to diameter “u” is between about 0.2 to 1.5, preferably between about 0.4 to 1.0, and more preferably between about 0.5 to 0.8. Separating inner portion 17 from inner portion 25 (and in effect inlet 14 from contaminated water outlet 22) by horizontal distance “v” helps to reduce the amount of inflowing contaminated water entering inlet 14 that undesirably skips over outlet 22 and exits the T-piece 10 through outlet 18.

As is best seen in FIG. 2A, the sum of diameter “u” and distance “v” is approximately equal to the overall longitudinal (horizontal) length of the central chamber between inner portions 17 and 21 (in effect inlet 14 and outlet 18). The length of the central chamber, i.e. the sum of “u” and “v”, is greater than diameter “u” to further reduce the amount of initial flowing contaminated water that undesirably skips, jumps, or splashes over contaminated water outlet 22 and exits the T-piece 10 through uncontaminated water outlet 18, even if the water is moving fast. For instance, the length of the central chamber may be between about 1.2 to 3 times greater than diameter “u”. Preferably, the length of the central chamber is between about 1.3 to 2 times greater than diameter “u”. More preferably, the length of the central chamber is between about 1.4 to 1.7 times greater than diameter “u”.

The generally rectangular top of the T-piece 10 is comprised of a top face 26 and an inclined top surface 27 that extends away from and below the top face 26. The top face 26 and inclined top surface 27 may be manufactured as a separate piece that is then joined to T-piece 10. Alternatively, the top face 26 and inclined top surface 27 may be manufactured integrally with T-piece 10.

The lower peripheral edge of inclined top surface 27 meets with the upper edges of the generally vertical side walls and end walls of the central chamber of T-piece 10. The T-piece 10 has a first side wall 30, second side wall 31, first end wall 32, and second end wall 33. The side walls 30, 31 oppose each other and the end walls 32, 33 oppose each other. The side walls 30 and 31 are separated by a distance “y” labelled in FIG. 2E. The distance “y” between the side walls 30, 31 is greater than the diameter “w” of the inner portion 17 of inlet 14. Importantly, this results in the internal walls inside the chamber flaring out from, and being wider than, the diameter “w” of inner portion 17 and there is a discontinuity where the internal walls and inner portion 17 are joined. Preferably, the distance “y” is between about 130 to 180 mm, preferably 130 to 150 mm, and more preferably about 140 mm. Preferably, distance “y” is between about 1.1 to 1.6 times greater than diameter “w”. More preferably, distance “y” is about 1.1 to 1.4 times greater than diameter “w”. Even more preferably, distance “y” is about 1.1 to 1.2 times greater than diameter “w”.

Inlet 14 projects away from first end wall 32 while outlet 18 projects away from second end wall 33. As is best seen in FIG. 2A, the principal axis of the inlet 14 is parallel or co-linear with the principal axis of the outlet 18. The principal axis of the outlet 22 is perpendicular to the principal axes of the inlet 14 and outlet 18. However, the principal axis of the outlet 22 need not be perpendicular to the principal axes of the inlet 14 and outlet 18. In fact, angles between about 30 and 60 degrees are possible. Thus, in an alternative embodiment the principal axis of the outlet 22 makes an angle between about 30° and 60°, this may sometimes be an approximately 45 degree angle, with the principal axis of the inlet 14 (in which case the fall pipe may not be exactly vertical, at least where it connects to outlet 22; but it should still be “vertical enough” to function as required).

Below the side walls 30, 31 and first end wall 32 is a depressed pouch 34 that extends down toward inner portion 25 of contaminated water outlet 22. The depressed pouch 34 lowers the position of a float 53 where float 53 closes (seals) water outlet 22 as will be described below with respect to the water diverter 48 in FIG. 3B. This allows for uncontaminated water 57 to flow more freely and easily through T-piece 10 and on to a storage area. The height of the depressed pouch 34 is shown by vertical distance “x” in FIG. 2A. Distance “x” separates inner portion 17 from inner portion 25 and is not limited in any way. For instance, distance “x” may have similar ranges as distance “v” described above. The ratio of distance “x” to diameter “w” may be between about 0.2 to 1.5, preferably between about 0.4 to 1.0, more preferably between about 0.5 to 0.8.

A curved wall 38 is located adjacent to the depressed pouch 34 and below the side walls 30, 31 and second end wall 33.

The top face 26, inclined top surface 27, side walls 30 and 31, end walls 32 and 33, depressed pouch 34, and curved wall 38 generally form and enclose the central chamber of T-piece 10. As can be observed in the figures, the vertical cross-sectional area of the central chamber at any point is larger than the vertical cross-sectional area of the inlet 14. It can also be observed that there is discontinuity in the internal surface where the inside of inlet 14 joins to the chamber wall. Consequently, fast flowing water will not simply be able to remain stuck (or cling) to the wall as it flows over this discontinuity, which means the water will become detached or separated from the wall and will begin to fall into outlet 22 under the influence of gravity.

Ridges 42 span the lower side of top face 26. As best observed in FIGS. 1D and 2B the ridges extend inwardly from the top of the T-piece towards the centre of the chamber and are spaced apart from one another in a parallel and perpendicular arrangement. Ridges 42 strengthen the top of the T-piece. Some of the water entering inlet 14 may also collide with one or more ridges 42 which further decrease the amount of water clinging to the interior surface of the central chamber and skipping over contaminated water outlet 22.

The T-piece may be made of plastic by injection moulding. The T-piece may be integrally formed in one piece. Alternatively, each feature of the T-piece may be manufactured separately prior to assembly of the T-piece. For example, the inlet 14 and outlets 18 and 22 may be individually manufactured then attached to the central chamber. As described above, the top face 26 and inclined top surface 27 may be manufactured separately then attached to the central chamber.

Importantly, there is a “surface discontinuity” between the interior surface of the inlet 14 and the interior surface of the central chamber. This surface discontinuity is created by the quite sharp edge or at least a very small, tightly curved/rounded (or bevelled) edge that exists between the interior surface of the inlet 14 and the adjoining outwardly expanding (flaring) portions of the chamber's interior surfaces. This surface discontinuity helps to prevent the initial flow of contaminated water (or indeed any flow of water, contaminated or not) entering inlet 14 from clinging to the interior surface sidewalls of the central chamber. Instead, even if there is any water that is stuck or clinging to the sidewalls of the inlet pipe or sloshing up the sidewalls prior to and upon entering inlet 14, as the flow passes through inlet 14 and into the chamber, and in particular as it flows over the surface discontinuity, the flow (due to the speed, weight and hence momentum of the water) simply will not be able to maintain it's adherence to the wall, and the flow will instead become separated or detached from the wall and will generally continue out into the air inside the chamber, whereupon gravity will act on it causing it to fall into outlet 22. The discontinuity described above helps to cause the flow of water to separate from the internal wall. The greater distance between inner portions 17 and 21 (i.e. the sum of “u” plus “v”) relative to the diameter “u” of inner portion 25 further reduces the amount of water that skips or splashes directly over outlet 22.

The present applicant has found that the amount of contaminated water that undesirably skips over the contaminated water outlet 22 of T-piece 10 is at most 8% at high water flow rates and 0% at low flow rates. This is much less than the amount of water skipping over in the known T-piece referred to in the background section above (as much as 50%).

A water diverter 48 is illustrated in FIGS. 3A and 3B. Water diverter 48 has a T-piece 10, a horizontal inflow pipe 50 connected to inlet 14, a horizontal outflow pipe 51 connected to outlet 18, and a vertical fall pipe 52 connected to and extending below outlet 22. A float 53 is located inside fall pipe 52. The fall pipe 52 also has fall pipe outlet 54 with a valve 55 at its lower end. Water diverter 48 is configured for mounting in a suitable location e.g. on a domestic building or commercial business. For example, water diverter 48 may be mounted on or near the side of a residential house in close proximity to a water tank.

The water diverter 48 operates as follows. When it starts to rain, an initial flow of contaminated water 56 from a collection area such as the roof of a house passes through inlet pipe 50 and into T-piece 10 as shown by the dashed arrows in FIG. 3A. The contaminated water 56 may contain leaves, dirt, or bird droppings. Contaminated water 56 flows down into fall pipe 52. At this stage, valve 55 is closed and water 56 accumulates in fall pipe 52. The water 56 pushes up the float 53 in the direction of the solid arrow shown in FIG. 3A until float 53 contacts with, and closes, outlet 22 of T-piece 10 as shown in FIG. 3B. By then there should be little or no (or at least much less) unwanted dirt, leaves etc. in the water flowing from the collection area meaning that (mostly) uncontaminated water 57 is passing through inlet pipe 50, into T-piece 10, and out through pipe 51 on its way to a storage area (not shown) as shown by the dashed arrows in FIG. 3B. When the rain stops the flow of uncontaminated water 57 ceases. Valve 55 is opened and the contaminated water 56 is drained from fall pipe 52 through fall pipe outlet 54 and is run to waste. Valve 55 may be a slow-release valve (i.e. a slow drip valve) or a delayed-release valve. As the contaminated water 56 is drained, float 53 moves downward in the direction of the solid arrow in FIG. 3B towards the lower end of fall pipe 52. Outlet 22 of T-piece 10 is therefore once again open. The water diverter 48 is then ready to collect an initial flow of contaminated water 56 when the next rainfall arrives.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A T-piece for use in a water diverter, the T-piece comprising:
an inlet operable for connection to an at least approximately horizontal inflow pipe;
a first outlet operable for connection to the top of an at least approximately vertical fall pipe;
a second outlet operable for connection to an at least approximately horizontal outflow pipe;
a chamber between the inlet, the first outlet, and the second outlet;
wherein a portion of the chamber expands outwardly away from the inlet in order that inflowing water adhered or clinging to an internal surface of the inflow pipe or inlet becomes separated therefrom.

2. The T-piece of claim 1, wherein the vertical cross-sectional area of the chamber is larger than the vertical cross-sectional area of the inlet.

3. The T-piece of claim 1, wherein the length of the chamber between the inlet and the second outlet is greater than the distance across the first outlet.

4. The T-piece of claim 3, wherein the length of the chamber between the inlet and the second outlet is between about 1.2 to 3 times, preferably between about 1.3 to 2 times, and more preferably between about 1.4 to 1.7 times greater than the distance across the first outlet.

5. The T-piece of claim 1, wherein the first outlet is closer to the second outlet than to the inlet.

6. The T-piece of claim 1, wherein a horizontal distance separates the first outlet from the inlet.

7. The T-piece of claim 6, wherein the horizontal distance and the distance across the first outlet have a ratio between about 0.2 to 1.5, preferably between about 0.4 to 1.0, and more preferably between about 0.5 to 0.8.

8. The T-piece of claim 1, wherein a vertical distance separates the first outlet from the inlet.

9. The T-piece of claim 8, wherein the vertical distance and the distance across the inlet have a ratio between about 0.2 to 1.5, preferably between about 0.4 to 1.0, and more preferably between about 0.5 to 0.8.

10. The T-piece of claim 1, wherein the chamber comprises a depressed pouch extending between the inlet and the first outlet.

11. The T-piece of claim 1, wherein the chamber comprises:
a first side wall;
a second side wall opposing the first side wall;
a first end wall; and
a second end wall opposing the first end wall.

12. The T-piece of claim 11, wherein the distance between the first side wall and the second side wall is greater than the distance across the inlet.

13. The T-piece of claim 12, wherein the ratio of the distance between the side walls and the distance across the inlet is between about 1.1 to 1.6, preferably between about 1.1 to 1.4, and more preferably between about 1.1 to 1.2.

14. The T-piece of claim 11, wherein the inlet projects away from the first end wall and the second outlet projects away from the second end wall.

15. The T-piece of claim 1, wherein the chamber comprises a top face and an inclined top surface that extends away from and below the top face.

16. The T-piece of claim 15, further comprising one or more ridges on the lower side of the top face.

17. The T-piece of claim 16, comprising a plurality of ridges spaced apart from each other in a parallel and/or perpendicular arrangement.

18. The T-piece of claim 1, wherein the top face and the inclined top surface are manufactured together as a separate piece that is attached to the chamber.

19. The T-piece of claim 1, wherein the T-piece is made of plastic.

20. The T-piece of claim 1, wherein the inlet, first outlet, and second outlet each independently comprise:
an outer portion;
an inner portion;
and an intermediate portion between the outer portion and the inner portion.

21. The T-piece of claim 20, wherein the distance across the outer portion is greater than the distance across the inner portion by up to about 5 mm, and wherein the distance across the intermediate portion progressively decreases from the outer portion to the inner portion.

22. A water diverter comprising:
a T-piece according to any one of the preceding claims;
an at least approximately horizontal inflow pipe connected to the inlet of the T-piece for passage of contaminated water and uncontaminated water from a collection area;
an at least approximately vertical fall pipe connected to and extending down from the first outlet of the T-piece for receiving contaminated water exiting the T-piece; and
an at least approximately horizontal outflow pipe connected to the second outlet of the T-piece for passage of uncontaminated water to a storage area.

23. The water diverter of claim 22, further comprising a float located inside the fall pipe adapted to reversibly close the first outlet of the T-piece.

24. The water diverter of claim 22, wherein the fall pipe has a fall pipe outlet with a valve at the lower end of the fall pipe.

25. A pipe T-piece comprising a chamber that has a first opening, a second opening, and a third opening, wherein
the first, second and third openings each include a round portion extending out from the chamber,
each said round portion is substantially cylindrical or at least round in cross section;
the principal axis of the first opening's round portion is parallel or co-linear with the principal axis of the second opening's round portion;
the principal axis of the third opening's round portion is at an angle to the principal axes of the first and second openings' round portions;
at least where the first opening's round portion joins the chamber, moving in a direction into the chamber, the internal wall of the chamber diverges outwards from the internal wall of the first opening's round portion such that, at least near where the first opening's round portion joins the chamber, the chamber is wider in all dimensions than the first opening; and
where the first opening's round portion joins the chamber, at the join there is a sharp edge or at least a very small, tightly curved/rounded (or beveled) edge.

26. The pipe T-piece of claim 25, wherein at least where the second opening's round portion joins the chamber, moving in a direction into the chamber, the internal wall of the chamber diverges outwards from the internal wall of the second opening's round portion such that, at least near where the second opening's round portion joins the chamber, the chamber is wider in all dimensions than the second opening, and
wherein the second opening's round portion joins the chamber, at the join there is a quite sharp edge or at least a very small, tightly curved/rounded (or beveled) edge.

27. The pipe T-piece of claim 25, wherein the size of the chamber in a dimension parallel with the principal axes of the first and second openings' round portions is such that the distance between where the first opening's round portion joins the chamber and where the second opening's round portion joins the chamber is greater than size than the third opening.

28. The pipe T-piece of claim 25, wherein the third opening's round portion joins the chamber at a location that is closer to where the second opening's round portion joins the chamber and further away from where the first opening's round portion joins the chamber.
